(19) United States
(12) Patent Application Publication
(10) Pub. No.: US 2026/0105577 A1
(43) Pub. Date: Apr. 16, 2026

(54) IMAGE GENERATION METHOD AND IMAGE PROCESSING SYSTEM

(71) Applicant: Acer Incorporated, New Taipei City (TW)

(72) Inventors: Sheng-Hsiung Yao, New Taipei City (TW); Ling-Fan Tsao, New Taipei City (TW)

(73) Assignee: Acer Incorporated, New Taipei City (TW)

(21) Appl. No.: 18/976,295

(22) Filed: Dec. 10, 2024

(30) Foreign Application Priority Data
Oct. 11, 2024 (TW) 113138688

(51) Int. Cl. G06T 5/60; G06T 7/50; H04N 13/111; H04N 13/161; H04N 13/261

(52) U.S. Cl. CPC G06T 5/60; G06T 7/50; H04N 13/111; H04N 13/161; H04N 13/261; G06T 2207/20016; G06T 2207/20081

(57) ABSTRACT

Disclosed are an image generation method and an image processing system. The method includes: establishing a plurality of image processing models respectively corresponding to a plurality of candidate image sizes; obtaining a plurality of training data sets respectively corresponding to the candidate image sizes; using the training data sets to train the image processing models respectively; detecting a first image size of an input image; determining a target image processing model from the image processing models according to the first image size; processing the input image through the target image processing model to generate depth information corresponding to the input image; and generating a first output image and a second output image according to the depth information.

### CROSS-REFERENCE TO RELATED APPLICATION

This application claims the priority benefit of Taiwan application serial no. 113138688, filed on Oct. 11, 2024. The entirety of the above-mentioned patent application is hereby incorporated by reference herein and made a part of this specification.

### BACKGROUND

### Technical Field

The present disclosure relates to an image generation method and an image processing system.

### Description of Related Art

With the advancement of technology, image processing techniques have become increasingly diverse to meet user demands. In the relevant technological field, image processing and presentation techniques that utilize artificial intelligence models to convert two-dimensional images into three-dimensional images have garnered increasing attention. However, due to limitations in training data sources and inherent functional constraints of artificial intelligence models, even when an artificial intelligence model has been trained using a sufficiently large number of training samples during the training phase, upon deployment of the trained artificial intelligence model, should the sizes (e.g., resolution) of the images to be processed change, the image processing performance of the artificial intelligence model may not meet expectations, thereby potentially degrading the image quality of the subsequently generated three-dimensional images.

### SUMMARY

The present disclosure provides an image generation method and an image processing system that are capable of ameliorating the aforementioned issues.

An embodiment of the present disclosure provide an image generation method, including: establishing a plurality of image processing models, wherein the plurality of image processing models respectively correspond to a plurality of candidate image sizes; obtaining a plurality of training data sets, wherein the plurality of training data sets respectively correspond to the plurality of candidate image sizes; using the plurality of training data sets to train the plurality of image processing models respectively; detecting a first image size of an input image, wherein the input image is a two-dimensional image; determining a target image processing model from the plurality of image processing models according to the first image size; processing the input image through the target image processing model to generate depth information corresponding to the input image; and generating a first output image and a second output image according to the depth information, wherein the first output image and the second output image are utilized to form a three-dimensional image corresponding to the input image.

An embodiment of the present disclosure further provides an image processing system including a storage device and a processor. The storage device is configured to store a plurality of image processing models and a plurality of training data sets. The processor is coupled to the storage device. The processor is configured to: establish a plurality of image processing models, wherein the plurality of image processing models respectively correspond to a plurality of candidate image sizes; obtain the plurality of training data sets, wherein the plurality of training data sets respectively correspond to the plurality of candidate image sizes; use the plurality of training data sets to train the plurality of image processing models respectively; detect a first image size of an input image, wherein the input image is a two-dimensional image; determine a target image processing model from the plurality of image processing models according to the first image size; process the input image through the target image processing model to generate depth information corresponding to the input image; and generate a first output image and a second output image according to the depth information, wherein the first output image and the second output image are utilized to form a three-dimensional image corresponding to the input image.

Based on the foregoing, the image generation method and image processing system provided by the present disclosure enable, during the model training phase, the training of the plurality of image processing models for different image sizes. Subsequently, through dynamic detection of the image sizes of the input images, the target image processing model may be determined from the plurality of image processing models and utilized to generate depth information corresponding to the input image. This depth information may then be used to generate a first output image and a second output image. Notably, the first output image and the second output image may be employed to form a three-dimensional image corresponding to the input image. Consequently, even when the sizes (e.g., resolution) of the image to be processed change, the image quality of the three-dimensional image generated through the artificial intelligence model may still be effectively maintained or even enhanced, thereby ameliorating deficiencies existing in conventional image processing techniques.

### BRIEF DESCRIPTION OF THE DRAWINGS

FIG. 1 is a schematic diagram illustrating an image processing system according to an embodiment of the present disclosure.

FIG. 2 is a schematic diagram illustrating the training of an image processing model using different training data sets according to an embodiment of the present disclosure.

FIG. 3 is a schematic diagram illustrating the size adjustment operation performed on reference training images according to an embodiment of the present disclosure.

FIG. 4 is a schematic diagram illustrating the adjustment of logic layers in the image processing model based on different candidate image sizes according to an embodiment of the present disclosure.

FIG. 5 is a schematic diagram illustrating the generation of a first output image and a second output image based on an input image according to an embodiment of the present disclosure.

FIG. 6 is a flowchart illustrating an image generation method according to an embodiment of the present disclosure.

### DESCRIPTION OF THE EMBODIMENTS

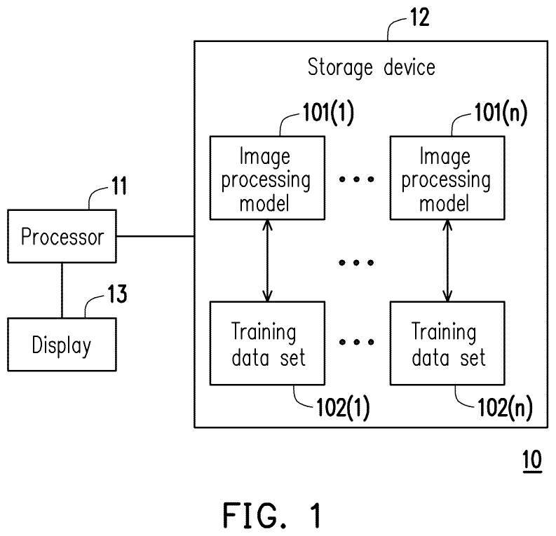

FIG. 1 illustrates a schematic diagram of an image processing system according to an embodiment of the present disclosure. Referring to FIG. 1, the image processing system 10 may be applied to or disposed in one or more electronic devices supporting image processing functions, such as, but not limited to, smartphones, tablet computers, laptop computers, desktop computers, servers, gaming consoles, or vehicular computers. The types of electronic devices are not limited to those enumerated herein.

The image processing system 10 includes a processor 11, a storage device 12, and a display 13. The processor 11 is responsible for the overall or partial operation of the image processing system 10. For instance, the processor 11 may include a Central Processing Unit (CPU), a Graphics Processing Unit (GPU), or other programmable general-purpose or special-purpose microprocessors, Digital Signal Processors (DSP), programmable controllers, Application Specific Integrated Circuits (ASIC), Programmable Logic Devices (PLD), or other similar devices, or a combination thereof.

In an embodiment, the processor 11 may further include specialized processors to assist in executing neural network operations and/or image processing, such as a Vision Processing Unit (VPU), a Neural Network Processing Unit (NPU), and/or a Tensor Processing Unit (TPU). Furthermore, the present disclosure does not limit the quantity or type of processors 11.

The storage device 12 is coupled to the processor 11 and is utilized for data storage. For instance, the storage device 12 may include volatile storage circuits and non-volatile storage circuits. The volatile storage circuits are employed for volatile data storage. By way of example, the volatile storage circuits may include Random Access Memory (RAM) or similar volatile storage media. The non-volatile storage circuits are employed for non-volatile data storage. For example, the non-volatile storage circuits may include Read Only Memory (ROM), solid state disks (SSD), Hard Disk Drives (HDD), or similar non-volatile storage media. Furthermore, the present disclosure does not impose limitations on the quantity or type of storage devices 12.

The display 13 is coupled to the processor 11 and is configured to present images. For example, the display 13 may include, but is not limited to, a Plasma Display, a Liquid Crystal Display (LCD), a Thin Film Transistor Liquid Crystal Display (TFT-LCD), an Organic Light-Emitting Diode (OLED) display, and a Light-Emitting Diode (LED) display, etc. Furthermore, the display 13 is not limited to the aforementioned types. For instance, the display 13 may be a head-mounted display or other types of displays.

In an embodiment, the processor 11 may establish image processing models 101(1) to 101(n). For instance, the total number of image processing models 101(1) to 101(n) may be any quantity greater than one, without limitation imposed by the present disclosure. The processor 11 may store the image processing models 101(1) to 101(n) in the storage device 12.

In an embodiment, any of the image processing models 101(1) to 101(n) may be individually employed to perform depth estimation on an image (also referred to as an input image) to generate depth information corresponding to the input image. For instance, the depth information may reflect the depth value corresponding to at least a portion of pixel position in the input image.

In an embodiment, any of the image processing models 101(1) to 101(n) may be implemented using a Multiple Depth Estimation Accuracy with Single Network (MiDaS) model, without limitation to this specific implementation. In an embodiment, any of the image processing models 101(1) to 101(n) may further be implemented using various operation architectures such as Deep Neural Networks (DNN), Recurrent Neural Networks (RNN), and/or Convolutional Neural Networks (CNN), or other neural network architectures or Artificial Neural Networks (ANN). The present disclosure is not restricted to any specific implementation in this regard.

In an embodiment, image processing models 101(1) to 101(n) correspond respectively to a plurality of image sizes (also referred to as candidate image sizes). Specifically, the plurality of candidate image sizes are distinct from one another.

In an embodiment, the image size of an image may be represented by the resolution or aspect ratio of the image. Taking resolution as an example, the image size of an image may be expressed as 512×288, 512×320, or 512×384, inter alia. Alternatively, using aspect ratio as an example, the image size of an image may be expressed as 16:9, 16:10, or 4:3, inter alia. Furthermore, any of the candidate image sizes may be configured or adjusted according to practical requirements, and the present disclosure does not impose limitations thereon.

In an embodiment, the processor 11 may obtain a plurality of training data sets 102(1) to 102(n). For example, the total number of training data sets 102(1) to 102(n) may be equal to the total number of image processing models 101(1) to 101(n). Furthermore, the processor 11 may store the training data sets 102(1) to 102(n) in the storage circuit 12.

In an embodiment, the training data sets 102(1) to 102(n) respectively correspond to the plurality of candidate image sizes. Specifically, analogous to the image processing models 101(1) to 101(n), the training data sets 102(1) to 102(n) may respectively correspond to different candidate image sizes.

In an embodiment, each of the training data sets 102(1) to 102(n) may include a plurality of images (also referred to as training images). In an embodiment, during the model training phase, the processor 11 may utilize the training data sets 102(1) to 102(n) to train the image processing models 101(1) to 101(n) respectively.

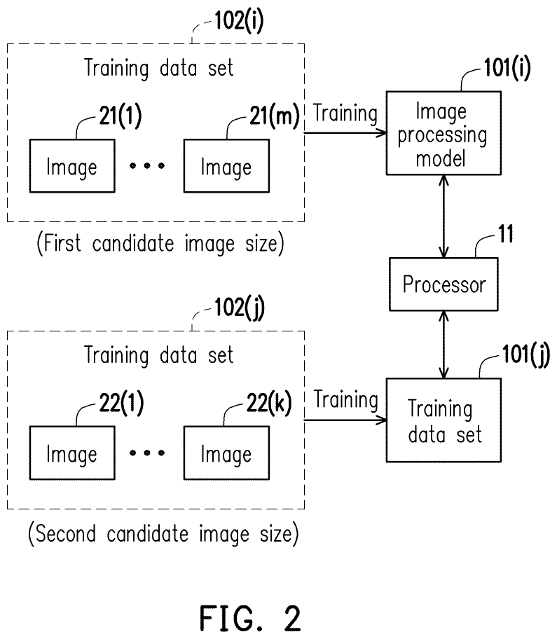

FIG. 2 is a schematic diagram illustrating the training of an image processing model using different training data sets according to an embodiment of the present disclosure. Referring to FIG. 2, assuming the training data sets 102(1) to 102(n) include training data sets 102(i) (also referred to as the first training data set) and 102(j) (also referred to as the second training data set), and the image processing models 101(1) to 101(n) include image processing models 101(i) (also referred to as the first image processing model) and 101(j) (also referred to as the second image processing model). i and j are integers between 1 and n, and i is different from j. Furthermore, assuming the training data set 102(i) includes images 21(1) to 21(m), and the training data set 102(j) includes images 22(1) to 22(k). For example, the images 21(1) to 21(m) and 22(1) to 22(k) are all training images. Additionally, m and k may both be any integer greater than 1.

In an embodiment, the images 21(1) to 21(m) all possess the same image sizes (also referred to as the first candidate image size). For instance, the first candidate image size may be 512×288 (or 16:9), though this disclosure is not limited to these specific sizes. In an embodiment, both the training data set 102(i) and the image processing model 101(i) correspond to the first candidate image size. In an embodiment, the processor 11 may (exclusively) utilize the images 21(1) to 21(m) from the training data set 102(i) to train the image processing model 101(i), thereby enhancing the capability of the image processing model 101(i) to predict depth information for images having the first candidate image size.

In an embodiment, the images 22(1) to 22(k) all possess the same image sizes (also referred to as the second candidate image size). It should be noted that the second candidate image size differs from the first candidate image size. For instance, the second candidate image size may be 512×384 (or 4:3), though this disclosure is not limited to these specific sizes. In an embodiment, the training data set 102(j) and the image processing model 101(j) both correspond to the second candidate image size. In an embodiment, the processor 11 may (exclusively) utilize the images 22(1) to 22(k) from the training data set 102(j) to train the image processing model 101(j), thereby enhancing the capability of the image processing model 101(j) to predict depth information for images having the second candidate image size.

In an embodiment, the processor 11 does not utilize the training data set 102(j) (e.g., images 22(1) to 22(k)) to train the image processing model 101(i), so as to avoid affecting the capability of the image processing model 101(i) to predict depth information for images having the first candidate image size. In an embodiment, the processor 11 does not employ the training data set 102(i) (e.g., images 21(1) to 21(m)) to train the image processing model 101(j), so as to avoid affecting the capability of the image processing model 101(j) to predict depth information for images having the second candidate image size.

In an embodiment, during the model implementation phase, the trained image processing model 101(i) (i.e., the first image processing model) is specifically utilized to process images (also referred to as the first images) having a first candidate image size, in order to accurately generate depth information (also referred to as the first depth information) corresponding to the first images. For instance, the first images may include any of the images 21(1) to 21(m). The first depth information may be used to describe the depth value corresponding to at least a portion of the pixel position in the first images.

In an embodiment, during the model application phase, the trained image processing model 101(j) (i.e., the second image processing model) is specifically utilized to process images (also referred to as second images) having a second candidate image size, in order to accurately generate depth information (also referred to as second depth information) corresponding to the second images. For instance, the second images may include any of the images 22(1) to 22(k). The second depth information may be used to describe the depth value corresponding to at least a portion of the pixel position in the second images.

In an embodiment, the accuracy of depth prediction performed by the trained image processing model 101(i) on an image (hereinafter referred to as the first image) having a first candidate image size may be higher than the accuracy of depth prediction performed by the trained image processing model 101(j) on the first image. In an embodiment, the accuracy of depth prediction performed by the trained image processing model 101(j) on an image (hereinafter referred to as the second image) having a second candidate image size may be higher than the accuracy of depth prediction performed by the trained image processing model 101(i) on the second image.

In an embodiment, the accuracy of depth prediction performed by the trained image processing model 101(i) on the first image may be higher than the accuracy of depth prediction performed by the trained image processing model 101(i) on the second image. In an embodiment, the accuracy of depth prediction performed by the trained image processing model 101(j) on the second image may be higher than the accuracy of depth prediction performed by the trained image processing model 101(j) on the first image.

In an embodiment, the processor 11 may acquire at least one image (also referred to as a reference training image). The reference training image may have at least one image size (also referred to as a reference image size). The processor 11 may perform a size adjustment operation on the reference training image to generate a training image having at least one image size (also referred to as a target candidate image size). For instance, the target candidate image size may differ from the reference image size. By way of example, the size adjustment operation may include image processing operations executed on the reference training image, such as scaling, cropping, rotation, and/or color adjustment, to alter the size, orientation, and/or color of the reference training image, inter alia. Subsequently, the processor 11 may incorporate the generated training image into the training data set corresponding to the target candidate image size among the training data sets 102(1) to 102(n).

In an embodiment, assuming the target candidate image size is the first candidate image size, the processor 11 may perform a size adjustment operation (also referred to as the first size adjustment operation) on the reference training image to generate a training image (also referred to as the first training image) having the first candidate image size. Subsequently, the processor 11 may incorporate the first training image into the training data set 102(i) (i.e., the first training data set) to augment the total number of the images 21(1) to 21(m) (i.e., training images) in the training data set 102(i).

In an embodiment, assuming the target candidate image size is the second candidate image size, the processor 11 may perform a size adjustment operation (also referred to as the second size adjustment operation) on the reference training image to generate a training image (also referred to as the second training image) having the second candidate image size. The first size adjustment operation may differ from the second size adjustment operation. Subsequently, the processor 11 may incorporate the second training image into the training data set 102(j) (i.e., the second training data set) to augment the total number of the images 22(1) to 22(k) (i.e., training images) in the training data set 102(j).

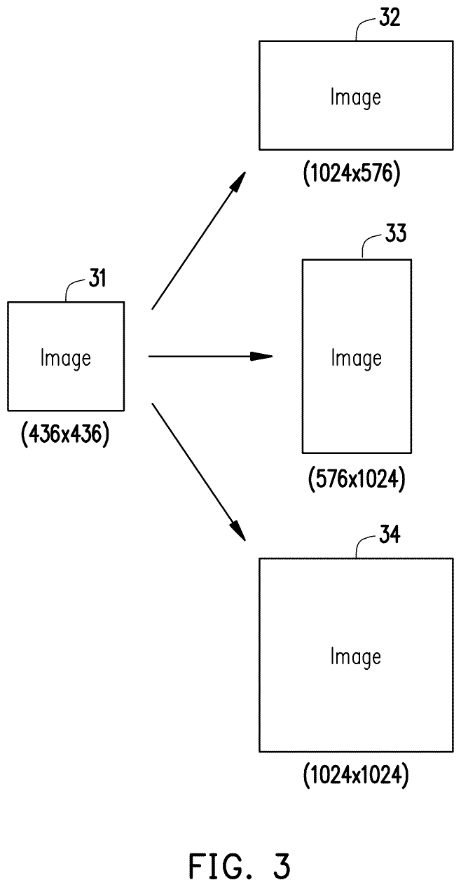

FIG. 3 is a schematic diagram illustrating the size adjustment operation performed on reference training images according to an embodiment of the present disclosure. Referring to FIG. 3, assume that image 31 is the reference training image. For example, the image size (i.e., the reference image size) of the image 31 may be 436×436, though the present disclosure is not limited thereto.

In an embodiment, the processor 11 may perform a plurality of size adjustment operations on the image 31 to generate images (i.e., training images) 32 to 34 having different image sizes, respectively. For example, the image sizes of the images 32 to 34 may be 1024×576, 576×1024, and 1024×1024, respectively, without limitation to these specific sizes. Subsequently, the processor 11 may, based on the respective image sizes of the images 32 to 34, incorporate each of the images 32 to 34 into at least one of the training data sets 102(1) to 102(n).

In an embodiment, the processor 11 may, based on the image size (hereinafter referred to as the first candidate image size) corresponding to the image processing model 101(i) (i.e., the first image processing model), adjust at least one logical layer in the image processing model 101(i) to render the adjusted logical layer suitable for processing the image (hereinafter referred to as the first image) having the first candidate image size. For instance, in an embodiment, assuming the image processing model 101(i) is initially unsuitable for processing the first image (e.g., unsuitable for performing depth prediction on the first image) or lacking the capability to process the first image (e.g., lacking the ability to perform depth prediction on the first image). Subsequent to adjusting at least one logical layer in the image processing model 101(i) based on the first candidate image size, the adjusted logical layer in the image processing model 101(i) may become suitable for processing the first image (e.g., suitable for performing depth prediction on the first image) or acquire the capability to process the first image (e.g., acquire the ability to perform depth prediction on the first image).

On the other hand, the processor 11 may, based on the image size (namely the second candidate image size) corresponding to the image processing model 101(j) (i.e., the second image processing model), adjust at least one logical layer in the image processing model 101(j), so as to render the adjusted logical layer suitable for processing the image (i.e., the second image) having the second candidate image size. For instance, in an embodiment, assuming that the image processing model 101(j) is initially not suitable for processing the second image (e.g., not suitable for performing depth prediction on the second image) or lacking the capability to process the second image (e.g., lacking the capability to perform depth prediction on the second image). After adjusting at least one logical layer in the image processing model 101(j) according to the second candidate image size, the adjusted logical layer in the image processing model 101(j) may become suitable for processing the second image (e.g., suitable for performing depth prediction on the second image) or acquire the capability to process the second image (e.g., acquire the capability to perform depth prediction on the second image).

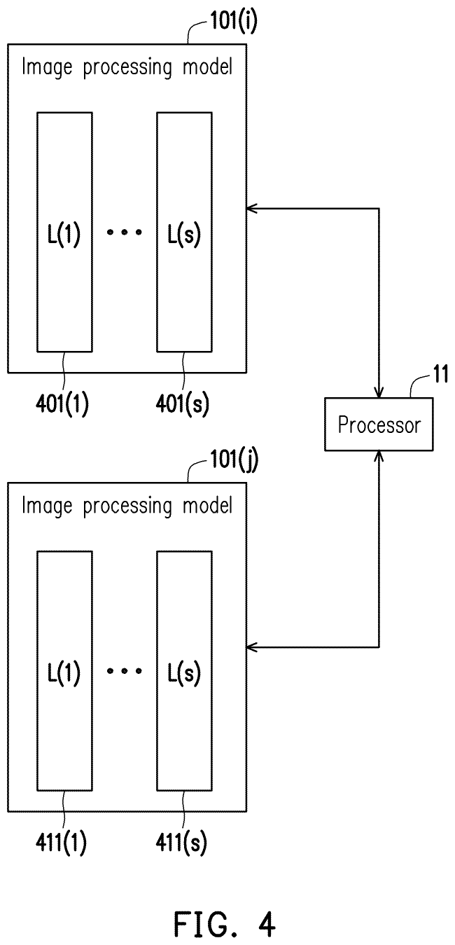

FIG. 4 is a schematic diagram illustrating the adjustment of logic layers in the image processing model based on different candidate image sizes according to an embodiment of the present disclosure. Referring to FIG. 4, it is assumed that the image processing model 101(i) includes logical layers 401(1) to 401(s) (denoted as L(1) to L(s)), and the image processing model 101(j) includes logical layers 411(1) to 411(s) (denoted as L(1) to L(s)).

In an embodiment, the processor 11 may adjust at least one of the logic layers 401(1) to 401(s) based on the first candidate image size, such that the adjusted logic layer (i.e., at least one of the logic layers 401(1) to 401(s)) is suitable for processing the image (i.e., the first image) having the first candidate image size. For example, the processor 11 may adjust the matrix operation size (also referred to as the first matrix operation size) supported by at least one of the logic layers 401(1) to 401(s) based on the first candidate image size, such that the adjusted first matrix operation size is identical to the first candidate image size.

In an embodiment, the processor 11 may adjust at least one of the logic layers 411(1) to 411(s) based on the second candidate image size, such that the adjusted logic layer (i.e., at least one of the logic layers 411(1) to 411(s)) is suitable for processing the image (i.e., the second image) having the second candidate image size. For example, the processor 11 may adjust the matrix operation size (also referred to as the second matrix operation size) supported by at least one of the logic layers 411(1) to 411(s) based on the second candidate image size, so that the adjusted second matrix operation size is identical to the second candidate image size.

In an embodiment, upon completion of the training of the image processing models 101(1) to 101(n), the processor 11 may acquire at least one image (hereinafter referred to as the input image) and detect the image size (also referred to as the first image size) of the input image. Specifically, the input image is a two-dimensional (2D) image.

In an embodiment, the processor 11 may determine an image processing model (hereinafter referred to as the target image processing model) from the image processing models 101(1) to 101(n) based on the first image size. In an embodiment, the image size (hereinafter referred to as the target image size) corresponding to the target image processing model is more proximate to the first image size compared to other image processing models among the image processing models 101(1) to 101(n). It should be noted that the target image size may be identical to or different from the first image size; the present disclosure does not impose any limitations in this regard.

In an embodiment, the processor 11 may compare the first image size with at least one of the plurality of candidate image sizes to obtain a comparison result. For instance, this comparison result may indicate which (i.e., the target image size) of the plurality of candidate image sizes is most proximate to (or identical with) the first image size. Subsequently, the processor 11 may determine the target image processing model from the image processing models 101(1) to 101(n) based on this comparison result. For example, the processor 11 may, based on this comparison result, designate the image processing model that corresponds to the target image size from the image processing models 101(1) to 101(n) as the target image processing model.

In an embodiment, the processor 11 may process the input image through a target image processing model to generate depth information corresponding to the input image. For instance, this depth information may reflect the depth value corresponding to at least a portion of pixel position in the input image. In an embodiment, this depth information may include a depth map corresponding to the input image.

In an embodiment, after obtaining depth information corresponding to the input image, the processor 11 may generate a first output image and a second output image based on this depth information. Specifically, the first output image and the second output image may be used to form a three-dimensional (3D) image corresponding to the input image. In an embodiment, the first output image and the second output image may respectively be the left eye image and the right eye image corresponding to the input image.

In an embodiment, upon obtaining the first output image and the second output image, the processor 11 may further instruct the display 13 to synchronously or interlacedly present the first output image and the second output image, thereby forming a three-dimensional image corresponding to the input image. The manner in which the display 13 synchronously or interlacedly presents the first output image and the second output image depends on the type of the display 13, and the present disclosure does not impose any limitations in this regard. Subsequently, when a user views the synchronously or interlacedly presented first output image and second output image on the display 13 with both eyes, the first output image and the second output image may form (or project) a three-dimensional image (i.e., a stereoscopic image) corresponding to the input image on the retinas of the user's eyes.

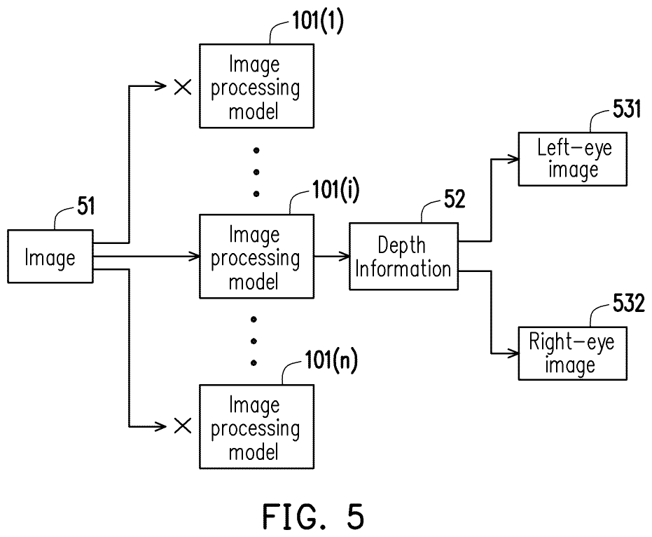

FIG. 5 is a schematic diagram illustrating the generation of a first output image and a second output image based on an input image according to an embodiment of the present disclosure. Referring to FIG. 5, assume an image 51 is the input image. Furthermore, assume that with respect to the image processing models 101(1) to 101(n), the image size (i.e., the first image size) of the image 51 most closely approximates (or is identical to) the candidate image size corresponding to the image processing model 101(i). For instance, if the first image size is 512×288 (or 16:9), then the candidate image size corresponding to the image processing model 101(i) is also 512×288 (or 16:9).

In an embodiment, upon detecting the image size (i.e., the first image size) of the image 51, the processor 11 may select the image processing model 101(i) from the image processing models 101(1) to 101(n) as the target image processing model based on the first image size. After determining the target image processing model (i.e., image processing model 101(i)), the processor 11 may input the image 51 into the image processing model 101(i) for processing, thereby executing depth prediction on the image 51 through the image processing model 101(i). Based on the processing result (i.e., the depth prediction result) of the image processing model 101(i) on the image 51, the processor 11 may obtain depth information 52 corresponding to the image 51. The processor 11 may generate a left eye image (i.e., the first output image) 531 and a right eye image (i.e., the second output image) 532 based on the depth information 52. The left eye image 531 and the right eye image 532 may be used to form a three-dimensional image (i.e., stereoscopic image) corresponding to the image 51. It should be noted that the operation of generating a left eye image (i.e., the first output image) and a right eye image (i.e., the second output image) based on the depth information is known in the art and will not be elaborated upon herein.

In an embodiment, the processor 11 may further acquire another image size (also referred to as a second image size). The second image size differs from the first image size. Subsequently, the processor 11 may, based on the second image size, adjust the image sizes of the first output image and the second output image from the first image size to the second image size. By way of example, as illustrated in FIG. 5, assuming that both the left eye image 531 and the right eye image 532 possess the first image size. Upon acquiring the second image size, the processor 11 may perform a size adjustment operation on the left eye image 531 and the right eye image 532, such that the adjusted left eye image 531 and right eye image 532 both possess the second image size.

In an embodiment, the processor 11 is capable of detecting the resolution of the display 13. Subsequently, the processor 11 may determine the second image size based on the resolution of the display 13. For instance, the processor 11 may set the second image size to be consistent with (e.g., identical or approximate to) the resolution of the display 13. As an illustrative example, assuming the first image size is 512×288 (or 16:9) and the resolution of the display 13 is 1440×1440, the processor 11 may set the second image size to 1440×1440 (or 1:1) in accordance with the resolution of the display 13. Thereafter, the processor 11 may adjust the image sizes of the left eye image 531 and the right eye image 532 simultaneously or sequentially to 1440×1440 (or 1:1) (i.e., the second image size). Consequently, during the period when the left eye image 531 and the right eye image 532 are presented on the display 13, the image presentation quality of the left eye image 531 and the right eye image 532 may be enhanced.

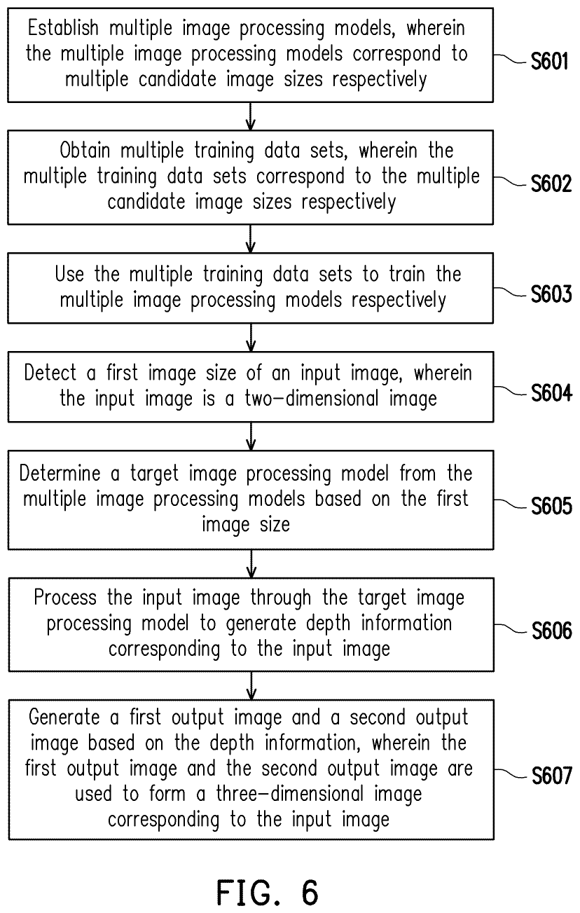

FIG. 6 is a flowchart illustrating an image generation method according to an embodiment of the present disclosure. Referring to FIG. 6, in step S601, a plurality of image processing models are established, wherein the plurality of image processing models respectively correspond to a plurality of candidate image sizes. In step S602, a plurality of training data sets are acquired, wherein the plurality of training data sets respectively correspond to the plurality of candidate image sizes. In step S603, the plurality of training data sets are used to train the plurality of image processing models respectively. In step S604, a first image size of an input image is detected, wherein the input image is a two-dimensional image. In step S605, based on the first image size, a target image processing model is determined from the plurality of image processing models. In step S606, the input image is processed through the target image processing model to generate depth information corresponding to the input image. In step S607, a first output image and a second output image are generated based on the depth information, wherein the first output image and the second output image are used to form a three-dimensional image corresponding to the input image.

However, the steps illustrated in FIG. 6 have been elucidated in detail as aforementioned, and therefore shall not be reiterated herein. It is noteworthy that the steps depicted in FIG. 6 may be implemented as a plurality of code segments or circuits, and the present disclosure does not impose any limitations in this regard. Furthermore, the method delineated in FIG. 6 may be employed in conjunction with the exemplary embodiments described above, or it may be utilized independently. The present disclosure does not impose any restrictions on such applications.

In light of the foregoing, the image generation method and image processing system proposed in the embodiments of the present disclosure enable, during the model training phase, the utilization of training data sets corresponding to various image sizes to train a plurality of image processing models. Subsequently, in the model application phase, the sizes of the input image may be detected to dynamically select an appropriate image processing model for processing the input image. In this way, the accuracy of prediction on depth information by the image processing model for the input image may be effectively enhanced, thereby improving the image quality of the subsequently generated (or presented) three-dimensional image, and effectively ameliorating the deficiencies existing in conventional image processing techniques.

Although the present disclosure has been disclosed by way of embodiments as described above, it is not intended to limit the scope of the disclosure. Any person of ordinary skill in the relevant art may make minor modifications and refinements without departing from the spirit and scope of this disclosure. Therefore, the scope to be protected by the present disclosure shall be defined by the appended claims.

What is claimed is:

1. An image generation method, comprising:
establishing a plurality of image processing models, wherein the plurality of image processing models respectively correspond to a plurality of candidate image sizes;
obtaining a plurality of training data sets, wherein the plurality of training data sets respectively correspond to the plurality of candidate image sizes;
using the plurality of training data sets to train the plurality of image processing models respectively;
detecting a first image size of an input image, wherein the input image is a two-dimensional image;
determining a target image processing model from the plurality of image processing models according to the first image size;
processing the input image through the target image processing model to generate depth information corresponding to the input image; and
generating a first output image and a second output image according to the depth information, wherein the first output image and the second output image are utilized to form a three-dimensional image corresponding to the input image.

2. The image generation method according to claim 1, wherein the plurality of image processing models comprise a first image processing model and a second image processing model, the first image processing model corresponds to a first candidate image size among the plurality of candidate image sizes, and the second image processing model corresponds to a second candidate image size among the plurality of candidate image sizes, and the step of using the plurality of training data sets to train the plurality of image processing models respectively comprises:
using a first training data set corresponding to the first candidate image size from the plurality of training data sets to train the first image processing model; and
using a second training data set corresponding to the second candidate image size from the plurality of training data sets to train the second image processing model.

3. The image generation method according to claim 2, wherein the trained first image processing model is specifically utilized to process a first image having the first candidate image size in order to generate first depth information corresponding to the first image, and
the trained first image processing model is specifically utilized to process a second image having the second candidate image size in order to generate second depth information corresponding to the second image.

4. The image generation method according to claim 1, wherein the step of obtaining the plurality of training data sets comprises:
obtaining a reference training image, wherein the reference training image has a reference image size;
performing a size adjustment operation on the reference training image to generate a training image having a target candidate image size from the plurality of candidate image sizes; and
incorporating the training image into a training data set corresponding to the target candidate image size among the plurality of training data sets.

5. The image generation method according to claim 1, wherein the step of establishing the plurality of image processing models comprises:
adjusting at least one logical layer in a first image processing model based on a first candidate image size corresponding to the first image processing model among the plurality of image processing models, such that the at least one logical layer is suitable for processing a first image having the first candidate image size.

6. The image generation method according to claim 1, wherein a target image size corresponding to the target image processing model is more proximate to the first image size compared to other image processing models among the plurality of image processing models.

7. The image generation method according to claim 1, wherein the step of determining the target image processing model from the plurality of image processing models according to the first image size comprises:
comparing the first image size with at least one of the plurality of candidate image sizes to obtain a comparison result; and
determining the target image processing model from the plurality of image processing models based on the comparison result.

8. The image generation method according to claim 1, wherein the step of generating the first output image and the second output image according to the depth information comprises:
obtaining a second image size, wherein the second image size differs from the first image size; and
adjusting image sizes of the first output image and the second output image from the first image size to the second image size based on the second image size.

9. The image generation method according to claim 8, wherein the step of obtaining the second image size comprises:
detecting a resolution of a display, wherein the display is by default used for presenting the first output image and the second output image; and
determining the second image size based on the resolution of the display.

10. An image processing system, comprising:
a storage device, configured to store a plurality of image processing models and a plurality of training data sets; and
a processor, coupled to the storage device,
wherein the processor is configured to:
establish a plurality of image processing models, wherein the plurality of image processing models respectively correspond to a plurality of candidate image sizes;
obtain the plurality of training data sets, wherein the plurality of training data sets respectively correspond to the plurality of candidate image sizes;
use the plurality of training data sets to train the plurality of image processing models respectively;
detect a first image size of an input image, wherein the input image is a two-dimensional image;
determine a target image processing model from the plurality of image processing models according to the first image size;
process the input image through the target image processing model to generate depth information corresponding to the input image; and
generate a first output image and a second output image according to the depth information, wherein the first output image and the second output image are utilized to form a three-dimensional image corresponding to the input image.

11. The image processing system according to claim 10, wherein the plurality of image processing models comprise a first image processing model and a second image processing model, the first image processing model corresponds to a first candidate image size among the plurality of candidate image sizes, and the second image processing model corresponds to a second candidate image size among the plurality of candidate image sizes, and the operation of the processor using the plurality of training data sets to train the plurality of image processing models respectively comprises:
using a first training data set corresponding to the first candidate image size from the plurality of training data sets to train the first image processing model; and
using a second training data set corresponding to the second candidate image size from the plurality of training data sets to train the second image processing model.

12. The image processing system according to claim 11, wherein the trained first image processing model is specifically utilized to process a first image having the first candidate image size in order to generate first depth information corresponding to the first image, and
the trained first image processing model is specifically utilized to process a second image having the second candidate image size in order to generate second depth information corresponding to the second image.

13. The image processing system according to claim 10, wherein the operation of the processor obtaining the plurality of training data sets comprises:
obtaining a reference training image, wherein the reference training image has a reference image size;
performing a size adjustment operation on the reference training image to generate a training image having a target candidate image size from the plurality of candidate image sizes; and
incorporating the training image into a training data set corresponding to the target candidate image size among the plurality of training data sets.

14. The image processing system according to claim 10, wherein the operation of the processor establishing the plurality of image processing models comprises:
adjusting at least one logical layer in a first image processing model based on a first candidate image size corresponding to the first image processing model among the plurality of image processing models, such that the at least one logical layer is suitable for processing a first image having the first candidate image size.

15. The image processing system according to claim 10, wherein a target image size corresponding to the target image processing model is more proximate to the first image size compared to other image processing models among the plurality of image processing models.

16. The image processing system according to claim 10, wherein the operation of the processor determining the target image processing model from the plurality of image processing models according to the first image size comprises:
comparing the first image size with at least one of the plurality of candidate image sizes to obtain a comparison result; and
determining the target image processing model from the plurality of image processing models based on the comparison result.

17. The image processing system according to claim 10, wherein the operation of the processor generating the first output image and the second output image according to the depth information comprises:
obtaining a second image size, wherein the second image size differs from the first image size; and
adjusting image sizes of the first output image and the second output image from the first image size to the second image size based on the second image size.

18. The image processing system according to claim 17, wherein the image processing system further comprises:
a display, coupled to the processor,
wherein the operation of the processor obtaining the second image size comprise:
detecting a resolution of the display, wherein the display is by default used for presenting the first output image and the second output image; and
determining the second image size based on the resolution of the display.
